(19) United States
(12) Patent Application Publication
(10) Pub. No.: US 2020/0372569 A1
(43) Pub. Date: Nov. 26, 2020

(54) CHATBOT CONVERSATION FEDERATION USING AUCTIONING

(71) Applicant: International Business Machines Corporation, Armonk, NY (US)

(72) Inventors: Kaushik Lahiri, KOLKATA (IN); Sarbajit K. Rakshit, KOLKATA (IN); Kuntal Dey, Vasant Kunj (IN); Mohit Jain, Bengaluru (IN)

(21) Appl. No.: 16/421,077

(22) Filed: May 23, 2019

(51) Int. Cl. G06Q 30/08; G06Q 30/06; H04L 12/58

(52) U.S. Cl. CPC G06Q 30/08; H04L 51/02; G06Q 30/0641

(57) ABSTRACT

A method, system and computer program product are disclosed for chatbot conversation using auctioning. In an embodiment, the method comprises a chatbot of a provider receiving a request from a customer for a product or service from the provider; the provider initiating an auction for the product or service with chatbots of a plurality of bidders; the provider identifying one of the bidders to supply the product or service; and the provider sending to the customer information to enable the customer to receive the product or service from the identified one of the bidders. In an embodiment, the provider initiating an auction includes the provider sending an auction request to an auction platform; and the provider identifying one of the bidders to supply the product or service includes the provider receiving from the auction platform a designation of one of the bidders.

### BACKGROUND

This invention generally relates to chatbots, and more specifically, to using chatbots to facilitate the purchase and sale of goods and services.

Chatbots are computer programs designed to simulate intelligent conversations with one or more users of a computing device. Many chatbots simulate a conversation with a user by providing a user interface in which the user of the chatbot, for example, inputs a question and the chatbot interprets the question and displays one or more answers in the user interface.

### SUMMARY

Embodiments of the invention provide a method, system and computer program product for chatbot conversation using auctioning. In an embodiment, the method comprises a chatbot of a product/service provider receiving a request from a customer for a product or service from the provider; the provider initiating an auction for the product or service with chatbots of a plurality of bidders; the provider identifying one of the bidders to supply the product or service for the customer; and the provider sending to the customer, by using the chatbot of the provider, information to enable the customer to receive the product or service from the identified one of the bidders.

In an embodiment, the provider initiating an auction includes the provider sending an auction request to an auction platform, and the provider identifying one of the bidders to supply the product or service includes the provider receiving from the auction platform a designation of one of the bidders.

In an embodiment, the provider identifying one of the bidders further includes the provider conducting a validation test, using specified criteria, of the designated one of the bidders; and if the designated one of the bidders passes the validation test, the provider selecting the designated one of the bidders to supply the product or service.

In an embodiment, the provider sending to the customer information to enable the customer to receive the product or service from the identified one of the bidders includes the provider initiating a multi-party chat between the provider's chatbot, a chatbot of the identified one of the bidders, and the customer.

Chatbots are used in customer-facing portals, through which a customer shops for goods and services. Embodiments of the invention use a chatbot front-facing mechanism for performing profitable commerce when a given provider (or business owner) cannot supply a product to an end-customer over the provider's own traditional sales medium (such as when the provider runs out of stock, or when the provider's manufacturers cannot supply the stock, or when the organization cannot ship out products from the organization's own repository for, as examples, audit, organizational or governance issues, etc.

Businesses (irrespective of whether they use chatbots or not) lose money when they cannot supply a demand raised by a (potential) customer, as the customer goes away to a competitor. It will be of commercial interest to the business to retain the customer by providing an alternative product/service (and even if, at times, the company cannot provide the alternate product/service, then to offer the product/service from other businesses for compensation). However, in spite of the advancement of the state of the art in the space of artificially intelligent chatbots, there is no capability to support such business situations/solutions.

As an example, in an embodiment of the invention, a cognitive chatbot of an e-commerce company C1 is front-facing on a multi-brand retail portal, where a customer uses the chatbot to ask for a specific brand of shoes, and the company does not have the specific shoe brand/model that the customer asked for. Rather than saying “sorry”, the chatbot, to maximize business, may launch an auction seeking alternative providers (other e-retailers) of the shoe, and either relay the messages of a winning bidder C2 to the customer, or, in an embodiment, allow the customer to interact with the winning bidder C2 via the company's (C1) chat portal and keeping C2 anonymous. Embodiments of the invention enable such capabilities, and bridge the gaps identified above

### BRIEF DESCRIPTION OF THE SEVERAL VIEWS OF THE DRAWINGS

FIG. 1 is an architectural diagram illustrating embodiments of the invention.

FIG. 2 diagrammatically illustrates embodiments of the invention.

FIG. 3 shows a bootstrap process used in embodiments of the invention.

FIG. 4 shows a call for auction used in embodiments of the invention.

FIG. 5 illustrates a validation and audit trail used in embodiments of the invention.

FIG. 6 illustrates a chatbot system that may be used in embodiments of the invention.

FIG. 7 depicts a cloud computing node that may be used in an embodiment of the present invention.

FIG. 8 depicts a cloud computing environment that may be used in an embodiment of the present invention.

FIG. 9 depicts abstraction model layers that may be used in an embodiment of the present invention.

### DETAILED DESCRIPTION

Embodiments of the invention provide a method, system and computer program product for chatbot conversation using auctioning. In an embodiment, the method comprises a chatbot of a product/service provider receiving a request from a customer for a product or service from the provider; the provider initiating an auction for the product or service with chatbots of a plurality of bidders; the provider identifying one of the bidders to supply the product or service for the customer; and the provider sending to the customer, by using the chatbot of the provider, information to enable the customer to receive the product or service from the identified one of the bidders.

Embodiments of the invention provide systems and methods for enabling a chatbot-to-chatbot conversation and federated conversation of chatbots-and-humans, via a provider triggering real-time calls for auction at chosen points in time, and allowing the auction winner to directly, anonymously or non-anonymously, interact with the end-customer via the interface and infrastructure of the provider, for the auction winner to perform commerce via the provider with the end-customer.

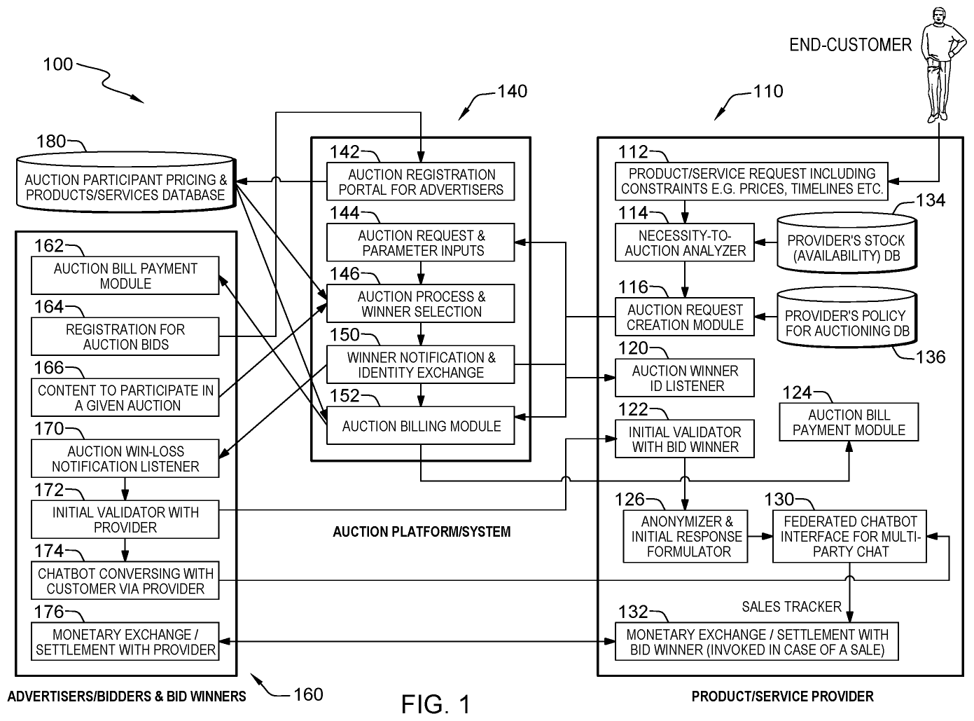

FIG. 1 is a System Architecture Diagram 100 of embodiments of the invention. As illustrated in FIG. 1, embodiments of the invention comprise three aspects: Product/Service Provider 110; Auction Platform/System 140; and Advertisers/Bidders and Bid Winners 160. The architecture of FIG. 1 also includes an Auction Participant Pricing and Products/Services database 180. Each of the aspects 110, 140 and 160 includes a number of components or modules

Product/Service Provider 110, in turn, includes product/service request including constraints 112, necessity-to-auction analyzer 114, auction request creation module 116, auction winner ID listener 120, and initial validator and bid winner 122. Product/Service Provider 110 also includes auction bill payment module 124, anonymizer and initial response formulator 126, federated chatbot interface for multiparty chat 130, and monetary exchange/settlement with bid winner 132. As shown in FIG. 1, Product Service Provider 110 further includes a provider's stock database 134, and a provider's policy for auctioning database 136.

With the embodiment illustrated in FIG. 1, Auction Platform/System 140 includes auction registration portal for advertisers 142, auction request and parameter inputs 144, and auction process and winner selection 146. This embodiment of Auction Platform/System also includes winner notification and identity exchange 150, and auction billing module 152.

The Advertisers/Bidders and Bid winners 160 of the architecture of FIG. 1 includes auction bill payment module 162, registration for auction bids 164, consent to participate in a given auction 166, and auction win-loss notification listener 170. This embodiment of the Advertisers/Bidders and Bid Winners further includes initial validator with provider 172, chatbot conversing with customer via provider 174, and monetary exchange/settlement with provider 176.

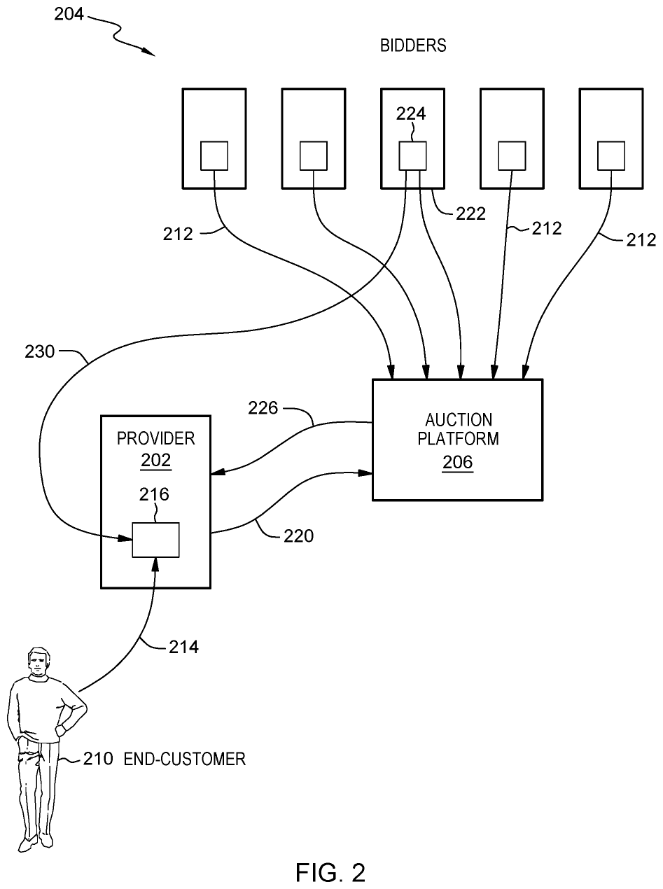

FIG. 2 diagrammatically illustrates an embodiment of the invention, and this Fig. shows a provider 202, a plurality of bidders/alternate providers 204, an auctioning platform 206 and an end-customer 210.

With reference to FIGS. 1 and 2, generally, in embodiments of the invention, at bootstrap, chatbot-based front-end customer service/guidance providing commercial entities 204 ensure, as represented at 212, that they make their chat protocols compatible to a specified federation mechanism; that is, these entities agree upon a standard message transfer protocol and use techniques known in the literature for cross-chatbot message passing. A necessity-to-auction determination process is carried out by a provider 202 of product/services, in response to a customer message 214 on the chatbot 216 of the provider. This process is in the form of analyzing the customer requirements (using NLP techniques) such as product name, desired speed (timeline/time guarantee) of delivery etc., stock analysis (using company-specific internal data assessment techniques), feasibility to deliver the order with sufficient profits etc., and identifying any gap between what the customer wants and what the provider can provide.

In case a necessity-to-auction is determined, an auction is requested, at 220, to an auctioning platform 206, with the customer's product/service requirements and customer-specified constraints as inputs. In an embodiment, the customer profile details are an additional input. A bid winner 222 is selected from the auction, wherein, the winner necessarily has a chatbot 224 that is compatible to the federation mechanism

In embodiments of the invention, the bid winner 222, the provider 202, none or both, as well as other bid participants, pay the auctioning platform 206, based upon factors such as memberships (the bidders can be a “monthly member” etc. to the auctioning platform), actions (the winner pays, the rest do not), exposure (the number of occasions that a bidder has been allowed to bid), etc. The auctioning platform, at 226, passes the bid winner's preferred chatbot ID as well as the winner's general identity over to the provider.

In an embodiment, the provider's chatbot 216 performs an initial interaction, represented at 230, with the bid winner's chatbot to validate (and record, for future audit-trails) the requirement type, volume, speed of delivery, pricing clauses and other factors that are parts of the auction. These factors often arise from customer needs, but can also comprise inter-organization contract clauses. In case of non-validation, the auction process is re-run, with the provider's request to the auctioning platform to exclude the current bid winner from the re-auction.

The provider 202 launches a multi-party chat between its own chatbot 216, the bid winner's 222 chatbot and the customer 210, and in an embodiment, the provider 202 anonymizes the winner's identity. In embodiments, eventually, the work flows normally as in other sale processes, and creates a multi-party chat window (and spawns a multi-party chat process accordingly) between the provider, the bid winner and the customer. If a sale happens, then a monetary settlement is performed between the provider and the bid winner, in the form of commission payouts from the bid winner to the provider, or revenue sharing, or other monetary contracts and artifacts (such as credit points, dispute settlements and so on). In an embodiment, the identity of the bid winner can be furnished to the end-customer on chat, for a premium commission paid by the bid winner to the provider.

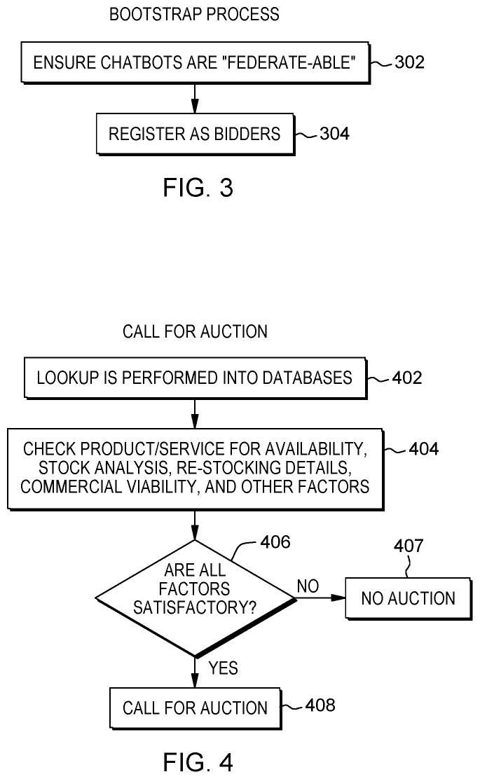

FIG. 3 illustrates a bootstrap process in more detail. In this phase, at 302, commercial entities adopting to embodiments of the invention ensure that their chatbots are federated-able, i.e., specified formats are used for data/message/text, and specified network protocols are used. To represent data/message/text, these commercial entities ensure that their chatbots understand a set of meta-tags and conventions specified in a globally understood language norm (such as XML, JSON, etc.). To follow specified network protocols, these commercial entities ensure that their chatbots understand published over-the-network exchange/control commands, such as “call to auction,” “selected as winner,” “validation message” “anonymization done” and so on. Further, in this phase, at 304, commercial entities adopting to embodiments of the invention also register themselves as bidders including budgets, product/keywords and so on, in the auction database.

FIG. 4 shows in more detail a “call for auction” by a provider of goods or services in accordance with embodiments of the invention. When a customer requests for a product/service on the chatbot (understood by state-of-the-art NLP and other techniques), a lookup is performed, at 402, into the stock/inventory database as well as corporate policy databases. As represented at 404, the product/service is checked for availability, stock analysis, re-stocking details, commercial viability, profitability, subject to customer constraints if any (such as timelines, price bargains/negotiations etc.). As represented at 406, the customer request is marked as “not-necessary-to-auction” in case all of these factors are satisfactory. Otherwise, an auction is requested to an auctioning platform, with the customer's product/service requirements and customer-specified constraints as inputs. In an embodiment, the customer profile details are provided as an additional input.

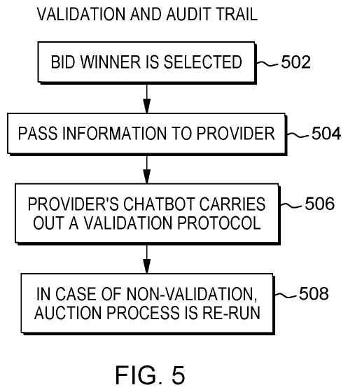

FIG. 5 illustrates in more detail an inter-chatbot chat for validation and audit trail purposes in accordance with an embodiment of the invention. A bid winner is selected, at 502, from the auction, wherein, the winner necessarily has a chatbot that is compatible to the federation mechanism. The auctioning platform, at 504, passes the bid winner's preferred chatbot ID as well as the identity of the bid winner over to the original product/service provider. The provider's chatbot, at 506, performs an initial chatbot-to-chatbot interaction with the bid winner's chatbot, carrying out a Validation Protocol to validate and record specified details or items for future audit-trails.

In embodiments of the invention, the validation and audit recording interaction comprises at least, but is not limited to, customer requirement type (product/service details), volume (number of items), speed (timeline) of delivery, pricing clauses, and other factors that are parts of the auction. These factors often arise from customer needs, but can also comprise the inter-organization contract clauses).

In case of non-validation, the auction process, at 510, is re-run. The provider requests the auctioning platform to exclude the current bid winner from the re-auction, to avoid unproductive repeat-processing.

In embodiments of the invention, an anonymization and initial response formulation that may be used. In an embodiment, the product/service provider first anonymizes the bid winner's chatbot ID. The product/service provider creates a local map for de-referencing, that records at least the following: a chat session identifier (the identifier of the current chat session); the true identity of the bid winner; and the anonymous ID of the bid winner. An initial response skeleton is created that comprises the anonymous identity of the bid winner, for further processing (instrumenting with an introductory message, as described below).

The message is instrumented to create real-life relevance to the customer. For example, the provider's chatbot could add, “I am now adding a trusted partner to this chatroom.” Such message augmentations can be done using existing templates, or in other embodiments, the message can be augmented via natural language generation techniques.

The product/service provider's chatbot now adds the bid winner's chatbot to the existing chat window or to a new chat window. In effect, this creates a three-party chat, between the provider's own chatbot, the bid winner's chatbot and the customer. In embodiments, the bid winner's identity is kept anonymous (the anonymous identity generated/created for the bid winner is used).

In embodiments of the invention, monetization can be done at multiple phases. In an example, the bid winner, the provider, none or both, as well as other bid participants, pay the auctioning platform, based upon factors such as memberships (the bidders can be a “monthly member” etc. to the auctioning platform), specified actions (the winner pays, the other bidders do not), exposure (the number of occasions that a bidder has been allowed to bid), etc.

As another example, if a sale happens, then a monetary settlement is performed between the provider and the bid winner, in the form of commission payouts from the bid winner to the provider, or revenue sharing, or other monetary contracts and artifacts (such as credit points, dispute settlements and so on). In an embodiment, the identity of the bid winner can be given to the end-customer on chat, in exchange for a premium commission paid by the bid winner to the provider.

As an example of an embodiment of this invention, E-Prominence is a retailer that sells products of multiple brands online. A customer is chatting with the intelligent chatbot on the portal of E-Prominence, and is asking for a specific model of shoes (“deliver by Monday”) that E-Prominence is out of stock, with no re-stocking information available. In a normal course, with a traditional system, the chatbot of E-Prominence would respond with, “Sorry we are out of stock, would you want to have the B model of F shoe maker instead?”. The customer would go away if the customer did not want that model, or at least, the customer would not be impressed by the absence of stock. This is not just a short-term loss of sale, but is a long-term loss of perception of the customer towards E-Prominence as well.

With embodiments of the invention, E-Prominence realizes that it does not have the shoes in stock, so it launches a call-to-auction, using the above-described auction framework, and specifying the specific shoe model and delivery timeline as the requirement. In an embodiment, this information is specified along with other known details of the customer that can be shared (such as location, some profile details etc.). Third-party inter-company advertisers that are capable of supplying the shoe, are registered with the system, and have federate-able chatbots (enabled with embodiments of the invention), respond, and a winner, say M, is selected from the bidders. The ID, including its chatbot handle, of M, is passed over to E-Prominence, and an internal ID of M with a nick name (that is meaningful to show to customers, but does not give the identity of M away) is created, say EM.

In this embodiment, the chatbot of E-Prominence proceeds for an initial discussion with the chatbot of M, to validate the auction outcome, which acts as an additional direct audit trail of the promise between the two parties. The auction can be re-run if the promise validation process deems the auction outcome as non-viable, with a request to exclude M. On the front-facing chat interface, E-Prominence responds to the customer saying, “Yes, I am connecting to our sales partner EM”, and invites EM to participate, and the chat becomes a three-party chat—with the customer, and the two bots. The sale happens, and E-Prominence is rewarded with a commission of the sale.

Embodiments of the invention monetize the auction from one or both of E-Prominence and M, as well as, possibly, from other bidders (in different bidding mechanisms, such as, pay-for-winning, pay-per-participation-in-auction etc.). In an embodiment, the identity of M can be provided to the end-customer on chat, in exchange for a premium commission that M pays to E-Prominence.

Both the buyer and the auction winner/seller do not need to have a separate auction platform of their own. It is the main seller (E-Prominence in this case) that enables the communication between the buyer and the auction winner/seller (post-validation) on the main seller's own auction platform using pseudo ids for both the buyer and the auction winner/seller.

In embodiments of the invention, customer's interactions, and associated chat details, selection of product, out of stock data, creation of auction, etc., can be gathered accordingly to identify the customer's need, selection of alternate supplier (if out of stock), etc. This information can be used for the proactive creation of stock of products using Supply Chain network, and can be prioritized for showing to the customer (for example, assigning a higher score/lower winning bid value, for the auction participant) while interacting with the chatbot.

Embodiments of the invention may implement a reverse auction. For scenarios where multiple provider chatbots request auctions of the same product, and only one provider site has the product in limited quantities, the auctioning platform can hold a reverse auction, where the privilege of requesting the product is first given to the highest bidding provider, then to the next highest bidders in order until product quantity becomes zero.

Also, embodiments of the invention may be used to enable premium pricing. For instance, chatbot to chatbot negotiations may determine that due to the high popularity of a provider chatbot, customers keep coming to that provider for a product, which it does not have, while another chatbot is always the auction winner, as this chatbot is the only one that has that product. In this situation, the two providers may jointly decide to charge a premium price for that product and share the additional mark-up profit.

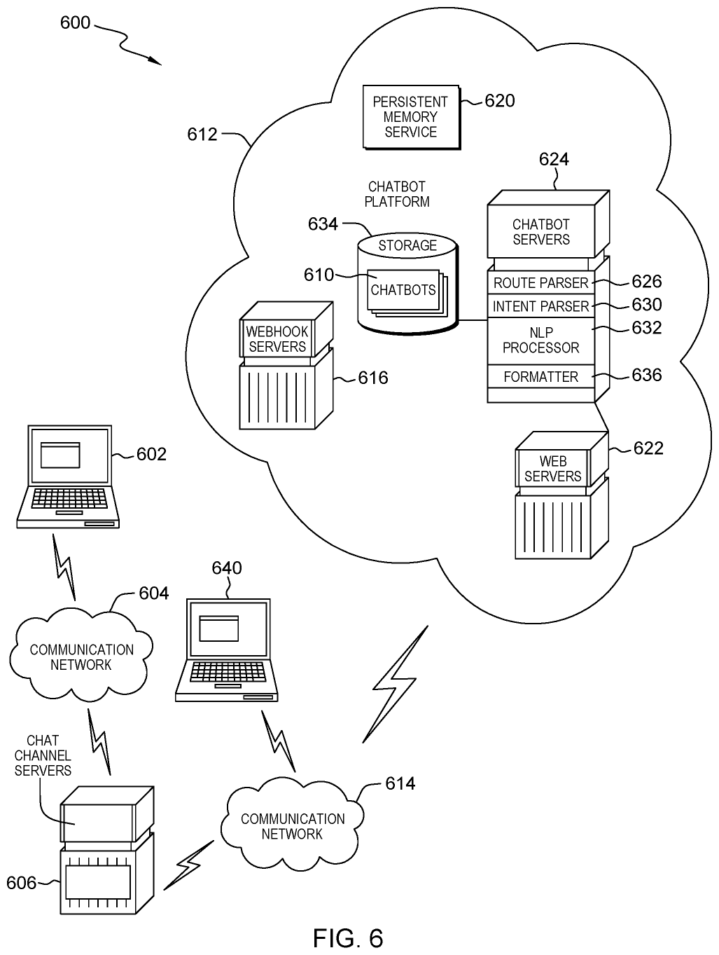

FIG. 6 is a block diagram showing in more detail a chatbot and a supporting system 600 for facilitating computer generated conversations that may be used in embodiments of the invention. The system 600 includes one or more user devices 602 that can connect via a communication network 604 to one or more servers 606 executing one or more communication channels, via an interface such as a web-browser or a dedicated application.

While the user device 602 is shown as a laptop, other kinds of user devices, such as desktop computers, smartphones, tables, and smart-watches, that can connect to a communication channel via the communication network 604 are possible. The communication network 604 can be a cellular network or the Internet, though other kinds of communication networks are also possible. The chat channels implemented by the servers 606 are services that can relay messages between two or more participants in a conversation. Examples of such channels include social networking chat services, as well as standalone messaging services, and SMS messaging services. Other kinds of chat channels are possible.

As described further below, one or more chatbots 610 can be registered with the chat channels, allowing a user of the chat channels to communicate with the chatbots 16 via the chat channel servers 606. Subsequently, after the user specifies to the chat channel services, the chatbot 610 that the user would like to communicate with, the messages sent from the computing device 602 during that conversation session would be forwarded by the chat channel servers 606 to the appropriate chatbot 610. The communication from the user of the computing device 602 can be in any format, including text, audio, or video communication.

The chatbots 610 are implemented as part of a chatbot platform 612, which can be implemented within a cloud-computing environment. Each chatbot 610 includes software modules that define the functionality of the chatbot and a workflow associated with that chatbot, a series of steps that the chatbot follows during a conversation with the user. In a further embodiment, the chatbot platform 612 can be implemented on dedicated servers in the same physical location.

Upon receiving a communication directed to one of the chatbots 610 in the chatbot platform 612, one or more of the chat channel servers 606 will send the communication to the chatbot platform 612 via a communication network 614. The communication network 614 can be the Internet or a cellular network, though other kinds of communication networks are possible. The communication network 614 can be the same network as the communication network 604, or a different network than the communication network 604.

The chatbot platform 612 includes one or more servers 616 (“webhook servers),” each of which is entry point and an exit point within the chatbot platform 612 for communications intended for and sent from a particular chatbot. Every chatbot 610 is associated with one of the webhook servers 616. The webhook servers receive the communication sent by the chat channel servers 606, and forward that communication for subsequent processing to other components of the platform 612. Upon the receipt of the communication, the webhook server 616 for a chatbot 610 that received the message performs an integrity check of the chat channel from which the communication was received via the communication network 614.

If the integrity check is successful, the webhook server 616 passes the received communication to other components of the platform 612 for further processing. If the integrity check is failed, the webhook server 616 returns to the chat channel servers 606 an error message, and no further processing of the received message takes place. In addition, upon a successful completion of the integrity check, the webhook server 616 can retrieve metadata needed for the operation of the chatbot 610. In addition, the webhook server 610 can store persistent data generated by the chatbot 610 in a persistent data storage service 620.

The received communication is passed from the webhook servers 616 to at least one web-server 622 with the chatbot platform 612, which can interpret the request that was included with the communication. Based on the request included with the communication, the web-server 622 determines the communication to include a message in need of a reply, and forwards the communication to one or more servers 624 implementing the chatbots 610 for subsequent processing.

The chatbot servers 624 implements a route parser 626, which determines the next step or steps in the workflow associated with the chatbot 610 that needs to be taken in response to the communication. The servers 624 further implement an intent parser 630 to determine an intent of the sender of the communication from the computing device 602. Such intent can include determining what language the communication was sent in and, thus the intent of the sender regarding what language the reply needs to be in. Further, when the sender's communication can have multiple meanings, the intent parser can determine the most likely meaning. The intent analyzer 630 can employ a natural language processor 632 to generate and send a clarifying question to the sender of the communication via the chat channel servers 606.

Once the intent is determined, the communication is passed to the chatbot 610 for which the communication is intended. The chatbots 610 can be stored in a storage 634 coupled to the servers 624 and retrieved when a server 624 needs a particular chatbot to respond to a user communication. As described above, each chatbot includes instructions to execute a workflow defined by the creator of that chatbot, a plurality of steps that define the interaction with a user and other parties during a conversation. In addition, the chatbot 610 can include a machine learning module (not shown), which can be trained, either on previous interactions with users or on other kinds of training samples, to classify the sender of the communication, either through using analysis of the message or using the information regarding the user obtained from an analytics service (not shown).

As part of the execution of a workflow, the chatbot 610 can utilize one or more application programming interfaces (APIs) included in the chatbot for interacting with third party services (not shown) that are accessible over the communication network 614. The chatbots 610 can further interact with still other services (not shown) and use the results of the interaction for generating the response communication.

As described above, the result of a running of a chatbot 610 is a response communication that is sent to the computing device 602 via the same chat channel that the initial communication was received from. The chatbot servers 624 further execute a communication formatter 636, which prior to the communication being sent out to the computing device 602, is formatted for the requirements of the communication channel via which the response communication will be sent. As mentioned above, the communication sent from the computing device 602 can be in any medium, including text, video, and audio. Similarly, the response communication can be in any medium, including text, video, and audio.

Once the response communication is formatted, the response communication is sent by the chatbot server 624 to the webhook server that is associated to the chatbot that generated the message and into which the incoming communication for the chatbot was initially received. The webhook server in turn sends the response communication to the computing device 602 via the communication networks 604, 614 and the chat channel servers 606.

While the sender of the communication can use a conversation with a chatbot 610 to obtain information or to perform another online action, the chatbot platform 612 can also be used to facilitate conversation between multiple users who are using multiple communication channels. The conversation can begin by a first user requesting one of the chat channel servers 606 to create a chatroom. The request can be made before or after the user selects to talk to a chatbot 610. The chatroom is associated with an identifier, which is conveyed by one of the chat channel servers to the chatbot platform 612 via the communication network 614. The chatbot platform 612 can in turn provide the identifier to other chat channels with which the chatbot 610 is registered.

Subsequently, a second user, using a second computing device 640 and a second chat channel can select the chatroom, such as by searching identifiers of chatrooms that have been communicated to the different chat channel as being used for the conversation with the chatbot 610 in question. The communications posted by the first user into the chatroom are forwarded to the chatbot 610 by the chat channel servers 606 for the channel used for hosting the chatroom, as described above. Upon receiving the message, at least one chatbot server 624 formats the received communication for transmission to the second chat channel and sends the formatted communication to the second user via the second chat channel.

Likewise, the communications sent by the second user to the chatbot platform 612 via the second chat channel, are formatted for transmission to the first communication channel and sent by the chatbot platform 612 to the first communication channel for posting in the chatroom. Thus, the communications posted by the first user in the chatroom are forwarded by the chatbot platform 612 to the second user, and the communications sent by the second user are sent for posting in the chatroom, allowing both users to see each other's communications despite using different communication channels.

The servers 606, 610, 624 can each include one or more modules for carrying out the embodiments disclosed herein. The modules can be implemented as a computer program or procedure written as source code in a conventional programming language and that is presented for execution by the central processing unit as object or byte code. Alternatively, the modules could also be implemented in hardware, either as integrated circuitry or burned into read-only memory components, and each of the servers 32 can act as a specialized computer.

The chatbot platform 612 can further implement a plurality of security measures, including executing a firewall by the webhook servers 616, as well as requiring the user to perform additional log-in protocols.

As indicated above, the chatbots 610 and the chatbot platform 612 can be implemented within a cloud-computing environment.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

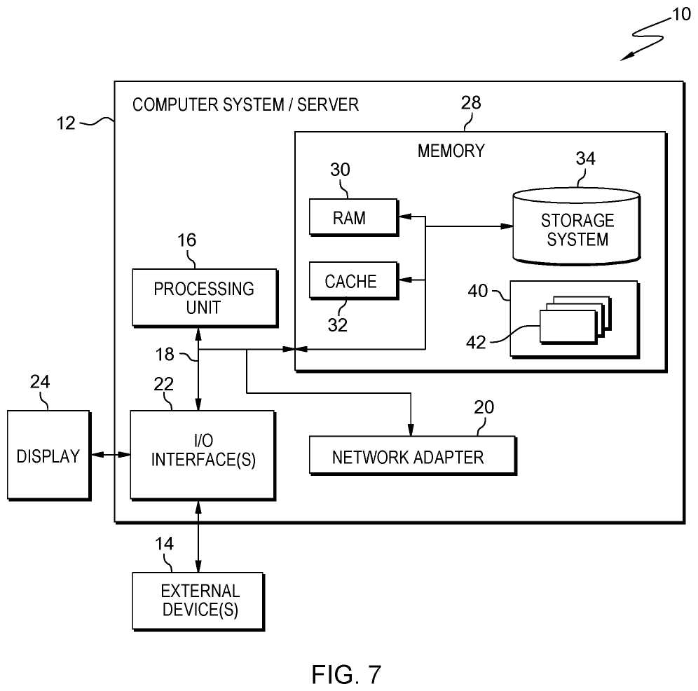

A cloud computing environment is service oriented with a focus on statelessness, low coupling, modularity, and semantic interoperability. At the heart of cloud computing is an infrastructure comprising a network of interconnected nodes. Referring now to FIG. 7, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

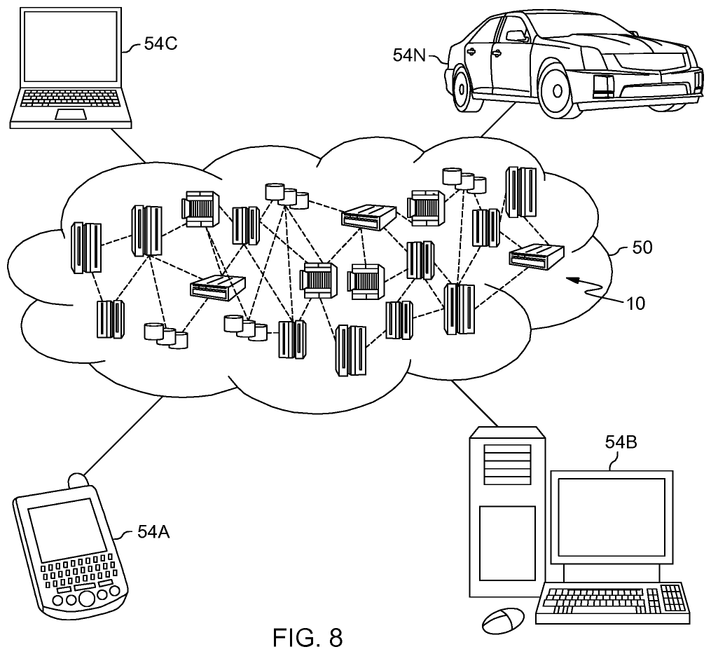

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

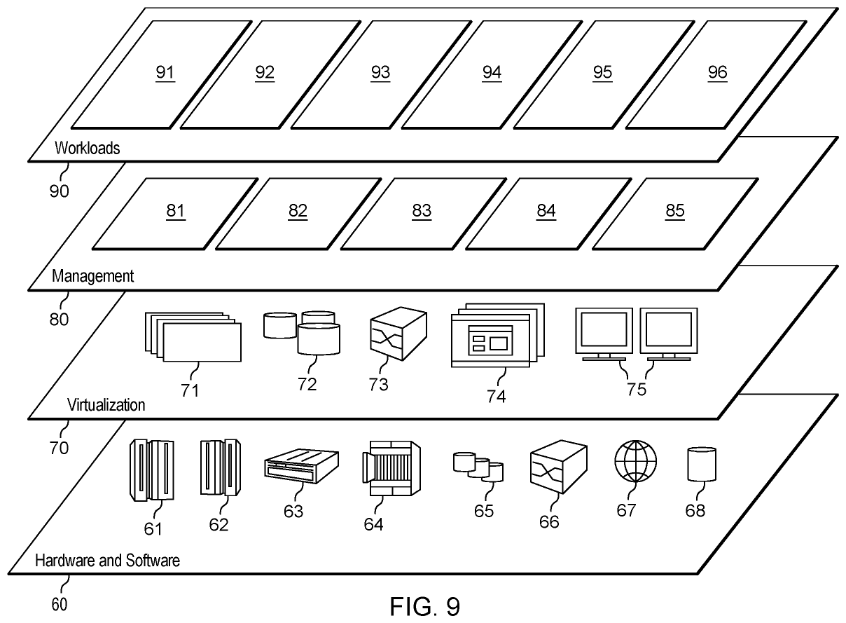

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto.

As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and chatbot conversation federation using auctioning 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of chatbot conversation using auctioning, the method comprising:
a chatbot of a provider receiving a request from a customer for a product or service from the provider;
the provider initiating an auction for the product or service with chatbots of a plurality of bidders;
the provider identifying one of the bidders to supply the product or service for the customer; and
the provider sending to the customer, by using the chatbot of the provider, information to enable the customer to receive the product or service from the identified one of the bidders.

2. The method according to claim 1, wherein:
the provider initiating an auction includes the provider sending an auction request to an auction platform; and
the provider identifying one of the bidders to supply the product or service includes the provider receiving from the auction platform a designation of one of the bidders.

3. The method according to claim 2, wherein the provider identifying one of the bidders further includes the provider conducting a validation test, using specified criteria, of the designated one of the bidders; and if the designated one of the bidders passes the validation test, the provider selecting the designated one of the bidders to supply the product or service.

4. The method according to claim 2, wherein the provider identifying one of the bidders further includes the provider conducting a validation test using specified criteria, of the designated one of the bidders; and if the designated one of the bidders does not pass the validation test, the provider sending a request to the auction platform to repeat the auction.

5. The method according to claim 2, wherein the provider identifying one of the bidders to supply the product or service further includes the chatbot of the provider initiating an interaction with a chatbot of the designated one of the bidders to validate specified factors of the auction.

6. The method according to claim 1, wherein the provider sending to the customer information to enable the customer to receive the product or service from the identified one of the bidders includes the provider initiating a multi-party chat between the provider's chatbot, a chatbot of the identified one of the bidders, and the customer.

7. The method according to claim 1, wherein the provider sending to the customer information to enable the customer to receive the product or service from the identified one of the bidders further includes the provider identifying to the customer the identified one of the bidders.

8. The method according to claim 1, wherein the provider initiating an auction includes:
the provider conducting a necessity-to-auction determination process in response to receiving the request from the customer for the product or service; and
the provider determining an auction is needed to provide the customer with the requested product or service.

9. The method according to claim 1, wherein the provider sending to the customer information to enable the customer to receive the product or service from the identified one of the bidders includes the provide sending to the customer said information while keeping the identified one of the bidders anonymous to the customer.

10. The method according to claim 1, wherein the provider sending to the customer information to enable the customer to receive the product or service from the identified one of the bidders includes initiating a chat session between the customer and a chatbot of the identified one of the bidders.

11. A system for chatbot conversation using auctioning, comprising:
one or more processors; and
a memory coupled to the one or more processors;
said one or more processors configured for:
receiving, at a chatbot of a computer system, a request from a customer for a product or service from a provider;
initiating an auction for the product or service with chatbots of a plurality of bidders; identifying one of the bidders to supply the product or service for the customer; and
sending to the customer, by using the chatbot of the computer system, information to enable the customer to receive the product or service from the identified one of the bidders.

12. The system according to claim 11, wherein:
the initiating an auction includes sending an auction request to an auction platform; and
the identifying one of the bidders to supply the product or service includes the receiving from the auction platform a designation of one of the bidders.

13. The system according to claim 12, wherein the identifying one of the bidders further includes conducting a validation test, using specified criteria, of the designated one of the bidders; and if the designated one of the bidders passes the validation test, selecting the designated one of the bidders to supply the product or service.

14. The system according to claim 12, wherein the identifying one of the bidders further includes conducting a validation test, using specified criteria, of the designated one of the bidders; and if the designated one of the bidders does not pass the validation test, sending a request to the auction platform to repeat the auction.

15. The system according to claim 11, wherein the sending to the customer information to enable the customer to receive the product or service from the identified one of the bidders includes
initiating a multi-party chat between the chatbot of the computer system, a chatbot of the identified one of the bidders, and the customer.

16. A computer program product for chatbot conversation using auctioning, the computer program product comprising a computer readable storage medium having program instructions embodied therewith, the program instructions executable by a processor to cause the processor to:
receive, at a chatbot of a computer system, a request from a customer for a product or service from the provider;
initiate, by the computer system, an auction for the product or service with chatbots of a plurality of bidders;
identify, by the computer system, one of the bidders to supply the product or service for the customer; and
send, by the computer system, to the customer, by using the chatbot of the provider, information to enable the customer to receive the product or service from the identified one of the bidders.

17. The computer program product according to claim 16, wherein:
initiating the auction includes sending an auction request to an auction platform; and
identifying one of the bidders to supply the product or service includes receiving from the auction platform a designation of one of the bidders.

18. The computer program product according to claim 17, wherein the identifying one of the bidders further includes the conducting a validation test, using specified criteria, of the designated one of the bidders; and if the designated one of the bidders passes the validation test, selecting the designated one of the bidders to supply the product or service.

19. The computer program product according to claim 17, wherein the identifying one of the bidders further includes the conducting a validation test, using specified criteria, of the designated one of the bidders; and if the designated one of the bidders does not pass the validation test, sending a request to the auction platform to repeat the auction.

20. The computer program product according to claim 16, wherein sending to the customer information to enable the customer to receive the product or service from the identified one of the bidders includes initiating a multi-party chat between the chatbot of the computer system, a chatbot of the identified one of the bidders, and the customer.
